(19) United States
(12) Patent Application Publication
(10) Pub. No.: US 2015/0365923 A1
(43) Pub. Date: Dec. 17, 2015

(54) METHODS AND APPARATUS FOR SIGNALING USER ALLOCATIONS IN MIXED MULTI-USER WIRELESS COMMUNICATION NETWORKS

(71) Applicant: QUALCOMM Incorporated, San Diego, CA (US)

(72) Inventors: Sameer Vermani, San Diego, CA (US); Rahul Tandra, San Diego, CA (US); Eric Pierre Rebeiz, Santa Clara, CA (US); Bin Tian, San Diego, CA (US)

(21) Appl. No.: 14/741,238

(22) Filed: Jun. 16, 2015

Related U.S. Application Data
(60) Provisional application No. 62/013,493, filed on Jun. 17, 2014.

(51) Int. Cl. H04W 72/04; H04B 7/04; H04J 11/00

(52) U.S. Cl. CPC H04W 72/042; H04J 11/00; H04B 7/0452; H04W 72/0453

(57) ABSTRACT

A method of wirelessly communicating a packet including a first portion for transmission over a channel of a first transmission type and a second portion for transmission over a channel of a second transmission type. In one aspect, the method includes generating a first signal field indicative of a channel assignment to the first transmission type. The method further includes generating a second signal field indicative of a channel assignment to the second transmission type. The method further includes transmitting, at a same time, the first signal field duplicated over each channel of the first transmission type, and the second signal field duplicated over each channel of the second transmission type.

### CROSS REFERENCE TO RELATED APPLICATIONS

This application claims priority to Provisional Application No. 62/013,493 entitled “METHODS AND APPARATUS FOR SIGNALING USER ALLOCATIONS IN MIXED MULTI-USER WIRELESS COMMUNICATION NETWORKS” filed Jun. 17, 2014. The disclosure of Provisional Application No. 62/013,493 is hereby expressly incorporated in its entirety by reference herein.

### FIELD

Certain aspects of the present disclosure generally relate to wireless communications, and more particularly, to methods and apparatus for multiple user communication in a wireless network.

### BACKGROUND

In many telecommunication systems, communications networks are used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

As the volume and complexity of information communicated wirelessly between multiple devices continues to increase, overhead bandwidth required for physical layer control signals continues to increase at least linearly. The number of bits utilized to convey physical layer control information has become a significant portion of required overhead. Thus, with limited communication resources, it is desirable to reduce the number of bits required to convey this physical layer control information, especially as multiple types of traffic are concurrently sent from an access point to multiple terminals. For example, when an access point sends downlink communications to multiple terminals, it is desirable to minimize the number of bits required to control the downlink of all transmissions. Thus, there is a need for an improved protocol for transmissions to and from multiple terminals.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages can become apparent from the description, the drawings, and the claims. Note that the relative dimensions of the following figures may not be drawn to scale.

One aspect of the present disclosure provides a method of wirelessly communicating a packet including a first portion for transmission over a channel of a first transmission type and a second portion for transmission over a channel of a second transmission type. In one aspect, the method includes generating a first signal field indicative of a channel assignment to the first transmission type. The method further includes generating a second signal field indicative of a channel assignment to the second transmission type. The method further includes transmitting, at a same time, the first signal field duplicated over each channel of the first transmission type, and the second signal field duplicated over each channel of the second transmission type.

Another aspect of the present disclosure provides an apparatus configured to wirelessly communicate a packet comprising a first portion for transmission over a channel of a first transmission type and a second portion for transmission over a channel of a second transmission type. The apparatus comprises a processor configured to generate a first signal field indicative of a channel assignment to the first transmission type and generate a second signal field indicative of a channel assignment to the second transmission type. The apparatus comprises a transmitter configured to transmit, at a same time, the first signal field duplicated over each channel of the first transmission type and the second signal field duplicated over each channel of the second transmission type.

Another aspect of the present disclosure provides an apparatus for wirelessly communicating a packet comprising a first portion for transmission over a channel of a first transmission type and a second portion for transmission over a channel of a second transmission type. The apparatus comprises means for generating a first signal field indicative of a channel assignment to the first transmission type. The apparatus comprises means for generating a second signal field indicative of a channel assignment to the second transmission type. The apparatus comprises means for transmitting, at a same time, the first signal field duplicated over each channel of the first transmission type, and the second signal field duplicated over each channel of the second transmission type.

Another aspect of the present disclosure provides a non-transitory computer-readable medium comprising code that, when executed, causes an apparatus to generate a first signal field of a packet comprising a first portion for transmission over a channel of a first transmission type and a second portion for transmission over a channel of a second transmission type, the first signal field indicative of a channel assignment to the first transmission type. The code, when executed, further causes the apparatus to generate a second signal field indicative of a channel assignment to the second transmission type. The code, when executed, further causes the apparatus to transmit, at a same time, the first signal field duplicated over each channel of the first transmission type, and the second signal field duplicated over each channel of the second transmission type.

### BRIEF DESCRIPTION OF THE DRAWINGS

FIG. 1 illustrates an example of a wireless communication system in which aspects of the present disclosure can be employed.

FIG. 2 illustrates various components that can be utilized in a wireless device that can be employed within the wireless communication system of FIG. 1.

FIG. 3 illustrates a channel allocation for channels available for 802.11 systems.

FIGS. 4 and 5 illustrate data packet formats for several currently existing IEEE 802.11 standards.

FIG. 6 illustrates a frame format for the currently existing IEEE 802.11ac standard.

FIG. 7 illustrates an exemplary structure of a physical-layer packet which can be used to enable backward-compatible multiple access wireless communications.

FIG. 8 is a block diagram of an access point and stations in an OFDMA system, according to some implementations.

FIG. 9 is a block diagram of a mixed MU-MIMO and OFDMA system, according to some implementations.

FIG. 10 is a diagram of a mixed physical layer data unit (PPDU) packet format, including OFDMA and MU-MIMO portions, according to some implementations.

FIG. 11 illustrates portions of exemplary structures of a physical-layer packet, according to some implementations.

FIG. 12 shows another flowchart for an exemplary method of wireless communication that can be employed within the wireless communication system of FIG. 1.

### DETAILED DESCRIPTION

Various aspects of the novel systems, apparatuses, and methods are described more fully hereinafter with reference to the accompanying drawings. The teachings disclosed can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the application. For example, an apparatus can be implemented or a method can be practiced using any number of the aspects set forth herein. In addition, the scope of the application is intended to cover such an apparatus or method which is practiced using other structure, functionality, or structure and functionality in addition to or other than the various aspects of the application set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies can include various types of wireless local area networks (WLANs). A WLAN can be used to interconnect nearby devices together, employing widely used networking protocols. The various aspects described herein can apply to any communication standard, such as WiFi or, more generally, any member of the IEEE 802.11 family of wireless protocols. For example, the various aspects described herein can be used as part of an IEEE 802.11 protocol, such as an 802.11 protocol which supports orthogonal frequency-division multiple access (OFDMA) communications.

It can be beneficial to allow multiple devices, such as STAs, to communicate with an AP at the same time. The term “at a same time” may be considered to mean at exactly the same time, at substantially or essentially the same time allowing for small margins of error, or during overlapping time periods. For example, this can allow multiple STAs to receive a response from the AP in less time, and to be able to transmit and receive data from the AP with less delay. This can also allow an AP to communicate with a larger number of devices overall, and can also make bandwidth usage more efficient. By using multiple access communications, the AP can be able to multiplex OFDM symbols to, for example, four devices at once over an 80 MHz bandwidth, where each device utilizes 20 MHz bandwidth. Thus, multiple access can be beneficial in some aspects, as it can allow the AP to make more efficient use of the spectrum available to it.

It has been proposed to implement such multiple access protocols in an OFDM system such as the 802.11 family by assigning different subcarriers (or tones) of symbols transmitted between the AP and the STAs to different STAs. In this way, an AP could communicate with multiple STAs with a single transmitted OFDM symbol, where different tones of the symbol were decoded and processed by different STAs, thus allowing simultaneous data transfer to multiple STAs. These systems are sometimes referred to as OFDMA systems.

Such a tone allocation scheme is referred to herein as a “high-efficiency” (HE) system, and data packets transmitted in such a multiple tone allocation system can referred to as high-efficiency (HE) packets. Various structures of such packets, including backward compatible preamble fields are described in detail below.

Various aspects of the novel systems, apparatuses, and methods are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the application. For example, an apparatus can be implemented or a method can be practiced using any number of the aspects set forth herein. In addition, the scope of the application is intended to cover such an apparatus or method which is practiced using other structure, functionality, or structure and functionality in addition to or other than the various aspects of the application set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies can include various types of wireless local area networks (WLANs). A WLAN can be used to interconnect nearby devices together, employing widely used networking protocols. The various aspects described herein can apply to any communication standard, such as a wireless protocol.

In some aspects, wireless signals can be transmitted according to an 802.11 protocol. In some implementations, a WLAN includes various devices which are the components that access the wireless network. For example, there can be two types of devices: access points (APs) and clients (also referred to as stations, or STAs). In general, an AP can serve as a hub or base station for the WLAN and an STA serves as a user of the WLAN. For example, an STA can be a laptop computer, a personal digital assistant (PDA), a mobile phone, etc. In an example, an STA connects to an AP via a WiFi compliant wireless link to obtain general connectivity to the Internet or to other wide area networks. In some implementations an STA can also be used as an AP.

An access point (AP) can also include, be implemented as, or known as a base station, wireless access point, access node or similar terminology.

A station “STA” can also include, be implemented as, or known as an access terminal (AT), a subscriber station, a subscriber unit, a mobile station, a remote station, a remote terminal, a user terminal, a user agent, a user device, user equipment, or some other terminology. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured for network communication via a wireless medium.

As discussed above, certain of the devices described herein can implement an 802.11 standard, for example. Such devices, whether used as an STA or AP or other device, can be used for smart metering or in a smart grid network. Such devices can provide sensor applications or be used in home automation. The devices can instead or in addition be used in a healthcare context, for example for personal healthcare. They can also be used for surveillance, to enable extended-range Internet connectivity (e.g., for use with hotspots), or to implement machine-to-machine communications.

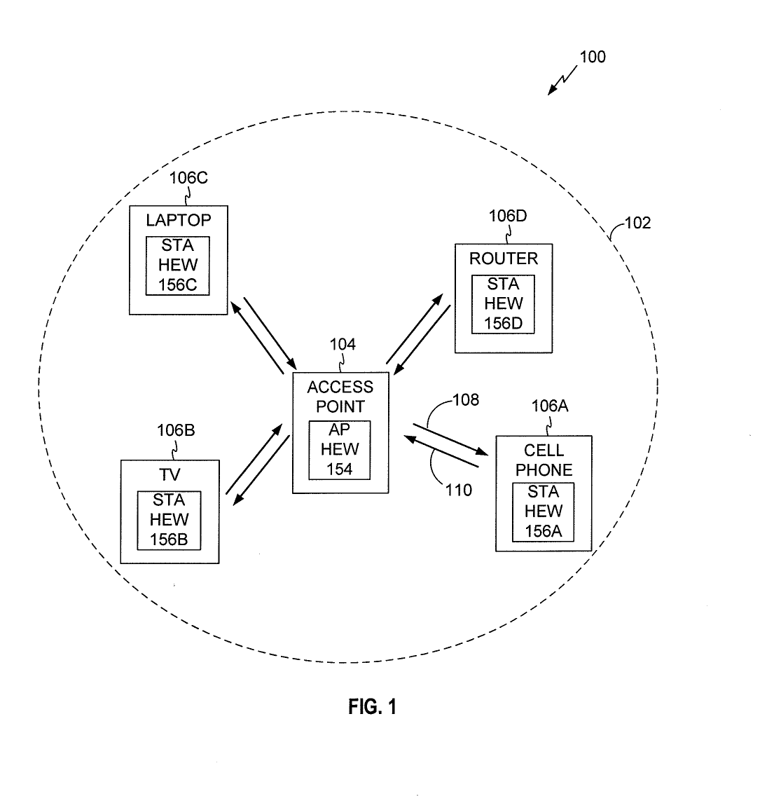

FIG. 1 illustrates an example of a wireless communication system 100 in which aspects of the present disclosure can be employed. The wireless communication system 100 can operate pursuant to a wireless standard, for example at least one of the 802.11ah, 802.11ac, 802.11n, 802.11g and 802.11b standards. The wireless communication system 100 can operate pursuant to a high-efficiency wireless standard, for example the 802.11ax standard. The wireless communication system 100 can include an AP 104, which communicates with STAs 106A-106D (which can be generically referred to herein as STA(s) 106).

A variety of processes and methods can be used for transmissions in the wireless communication system 100 between the AP 104 and the STAs 106A-106D. For example, signals can be sent and received between the AP 104 and the STAs 106A-106D in accordance with OFDM/OFDMA techniques. If this is the case, the wireless communication system 100 can be referred to as an OFDM/OFDMA system. Alternatively, signals can be sent and received between the AP 104 and the STAs 106A-106D in accordance with code division multiple access (CDMA) techniques. If this is the case, the wireless communication system 100 can be referred to as a CDMA system.

A communication link that facilitates transmission from the AP 104 to one or more of the STAs 106A-106D can be referred to as a downlink (DL) 108, and a communication link that facilitates transmission from one or more of the STAs 106A-106D to the AP 104 can be referred to as an uplink (UL) 110. Alternatively, a downlink 108 can be referred to as a forward link or a forward channel, and an uplink 110 can be referred to as a reverse link or a reverse channel.

The AP 104 can act as a base station and provide wireless communication coverage in a basic service area (BSA) 102. The AP 104 along with the STAs 106A-106D associated with the AP 104 and that use the AP 104 for communication can be referred to as a basic service set (BSS). It can be noted that the wireless communication system 100 may not have a central AP 104, but rather can function as a peer-to-peer network between the STAs 106A-106D. Accordingly, the functions of the AP 104 described herein can alternatively be performed by one or more of the STAs 106A-106D.

In some aspects, a STA 106 can be required to associate with the AP 104 in order to send communications to and/or receive communications from the AP 104. In one aspect, information for associating is included in a broadcast by the AP 104. To receive such a broadcast, the STA 106 can, for example, perform a broad coverage search over a coverage region. A search can also be performed by the STA 106 by sweeping a coverage region in a lighthouse fashion, for example. After receiving the information for associating, the STA 106 can transmit a reference signal, such as an association probe or request, to the AP 104. In some aspects, the AP 104 can use backhaul services, for example, to communicate with a larger network, such as the Internet or a public switched telephone network (PSTN).

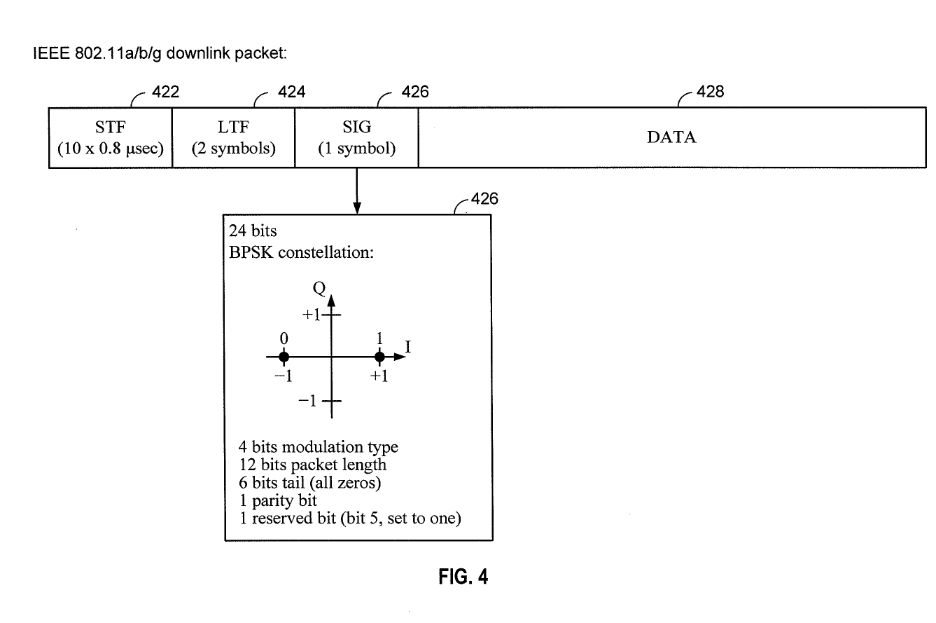

In some implementations, the AP 104 includes an AP high efficiency wireless controller (HEW) 154. The AP HEW 154 can perform some or all of the operations described herein to enable communications between the AP 104 and the STAs 106A-106D using the 802.11 protocol. The functionality of the AP HEW 154 is described in greater detail below with respect to FIGS. 4-20.

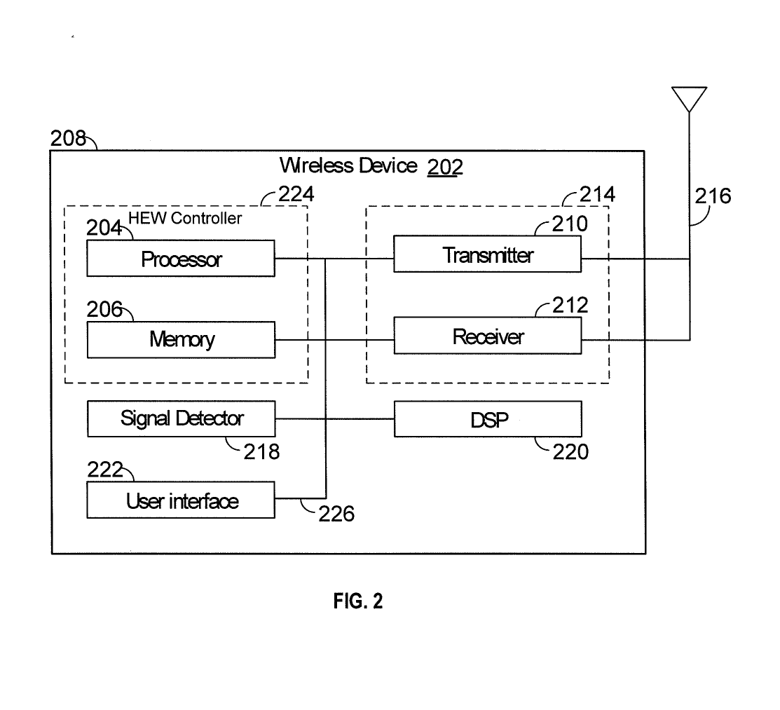

Alternatively or in addition, the STAs 106A-106D can include a STA HEW 156. The STA HEW 156 can perform some or all of the operations described herein to enable communications between the STAs 106A-106D and the AP 104 using the 802.11 protocol. The functionality of the STA HEW 156 is described in greater detail below with respect to FIGS. 2-11.

FIG. 2 illustrates various components that can be utilized in a wireless device 202 that can be employed within the wireless communication system 100 of FIG. 1. The wireless device 202 is an example of a device that can be configured to implement the various methods described herein. For example, the wireless device 202 can include the AP 104 or one of the STAs 106A-106D.

The wireless device 202 can include a processor 204 which controls operation of the wireless device 202. The processor 204 can also be referred to as a central processing unit (CPU) or hardware processor. Memory 206, which can include both read-only memory (ROM) and random access memory (RAM), provides instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein. In some implementations, the processor 204, and in some implementations the memory 206, may correspond to the HEW controllers 154, 156A-156D previously described in connection with FIG. 1.

The processor 204 can include or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processor 204 or the processor 204 and the memory 206 can correspond to the packet generator 124 of FIG. 1, which can be utilized to generate a packet including a value in a packet type field and to allocate a plurality of bits of the packet to each of a plurality of subsequent fields based at least in part on the value in the packet type field, as can be described in more detail below.

The processing system can also include non-transitory machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas, which can be utilized during multiple-input multiple-output (MIMO) communications, for example.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a data unit for transmission. In some aspects, the data unit can include a physical layer data unit (PPDU). In some aspects, the PPDU is referred to as a packet.

The wireless device 202 can further include a user interface 222 in some aspects. The user interface 222 can include a keypad, a microphone, a speaker, and/or a display. The user interface 222 can include any element or component that conveys information to a user of the wireless device 202 and/or receives input from the user.

The various components of the wireless device 202 can be coupled together by a bus system 226. The bus system 226 can include a data bus, for example, as well as a power bus, a control signal bus, and a status signal bus in addition to the data bus. Those of skill in the art can appreciate the components of the wireless device 202 can be coupled together or accept or provide inputs to each other using some other mechanism.

Although a number of separate components are illustrated in FIG. 2, those of skill in the art can recognize that one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

As discussed above, the wireless device 202 can include the AP 104 or one of the STAs 106A-106D, and can be used to transmit and/or receive communications. The communications exchanged between devices in a wireless network can include data units which can include packets or frames. In some aspects, the data units can include data frames, control frames, and/or management frames. Data frames can be used for transmitting data from an AP and/or a STA to other APs and/or STAs. Control frames can be used together with data frames for performing various operations and for reliably delivering data (e.g., acknowledging receipt of data, polling of APs, area-clearing operations, channel acquisition, carrier-sensing maintenance functions, etc.). Management frames can be used for various supervisory functions (e.g., for joining and departing from wireless networks, etc.).

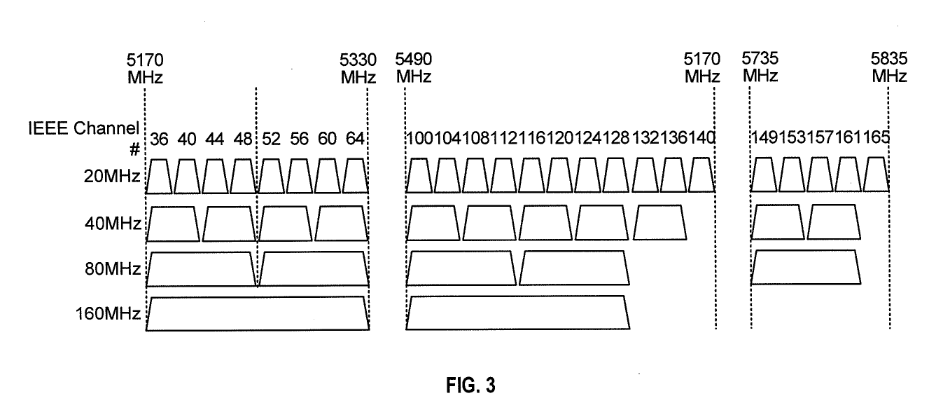

FIG. 3 illustrates a channel allocation for channels available for 802.11 systems. Various IEEE 802.11 systems support a number of different sizes of channels, such as 5, 10, 20, 40, 80, and 160 MHz channels. For example, and 802.11ac device can support 20, 40, and 80 MHz channel bandwidth reception and transmission. A larger channel can include two adjacent smaller channels. For example, an 80 MHz channel can include two adjacent 40 MHz channels. In the currently implemented IEEE 802.11 systems, a 20 MHz channel includes 64 subcarriers, separated from each other by 312.5 kHz. Of these subcarriers, a smaller number can be used for carrying data. For example, a 20 MHz channel can include transmitting subcarriers numbered −1 to −428 and 1 to 428, or 56 subcarriers. Some of these carriers can also be used to transmit pilot signals.

FIGS. 4 and 5 illustrate data packet formats for several currently existing IEEE 802.11 standards. Turning first to FIG. 4, a packet format for IEEE 802.11a, 11b, and 11g is illustrated. This frame includes a short training field 422, a long training field 424, and a signal field 426. The training fields do not transmit data, but they allow synchronization between the AP and the receiving STAs for decoding the data in the data field 428.

The signal field 426 delivers information from the AP to the STAs about the nature of the packet being delivered. In IEEE 802.11a/b/g devices, this signal field has a length of 424 bits, and is transmitted as a single OFDM symbol at a 6 Mb/s rate using BPSK modulation and a code rate of ½. The information in the SIG field 426 includes 4 bits describing the modulation scheme of the data in the packet (e.g., BPSK, 16QAM, 64QAM, etc.), and 12 bits for the packet length. This information is used by a STA to decode the data in the packet when the packet is intended for the STA. When a packet is not intended for a particular STA, the STA can defer any communication attempts during the time period defined in the length field of the SIG symbol 426, and can, to save power, enter a sleep mode during the packet period of up to about 5.5 msec.

As features have been added to IEEE 802.11, changes to the format of the SIG fields in data packets were developed to provide additional information to STAs. FIG. 5 shows the packet structure for the IEEE 802.11n packet. The 11n addition to the IEEE.802.11 standard added MIMO functionality to IEEE.802.11 compatible devices. To provide backward compatibility for systems including both IEEE 802.11a/b/g devices and IEEE 802.11n devices, the data packet for IEEE 802.11n systems also includes the STF, LTF, and SIG fields of these earlier systems, noted as L-STF 422, L-LTF 424, and L-SIG 426 with a prefix L to denote that they are “legacy” fields. To provide the needed information to STAs in an IEEE 802.11n environment, two additional signal symbols 440 and 442 were added to the IEEE 802.11n data packet. In contrast with the SIG field and L-SIG field 426, however, these signal fields used rotated BPSK modulation (also referred to as QBPSK modulation). When a legacy device configured to operate with IEEE 802.11a/b/g receives such a packet, it can receive and decode the L-SIG field 426 as a normal 11/b/g packet. However, as the device continued decoding additional bits, they may not be decoded successfully because the format of the data packet after the L-SIG field 426 is different from the format of an 11/b/g packet, and the CRC check performed by the device during this process can fail. This causes these legacy devices to stop processing the packet, but still defer any further operations until a time period has passed defined by the length field in the initially decoded L-SIG. In contrast, new devices compatible with IEEE 802.11n would sense the rotated modulation in the HT-SIG fields, and process the packet as an 802.11n packet. Furthermore, an 11n device can tell that a packet is intended for an 11/b/g device because if it senses any modulation other than QBPSK in the symbol following the L-SIG 426, it can ignore it as an 11/b/g packet. After the HT-SIG1 and SIG2 symbols, additional training fields suitable for MIMO communication are provided, followed by the data 428.

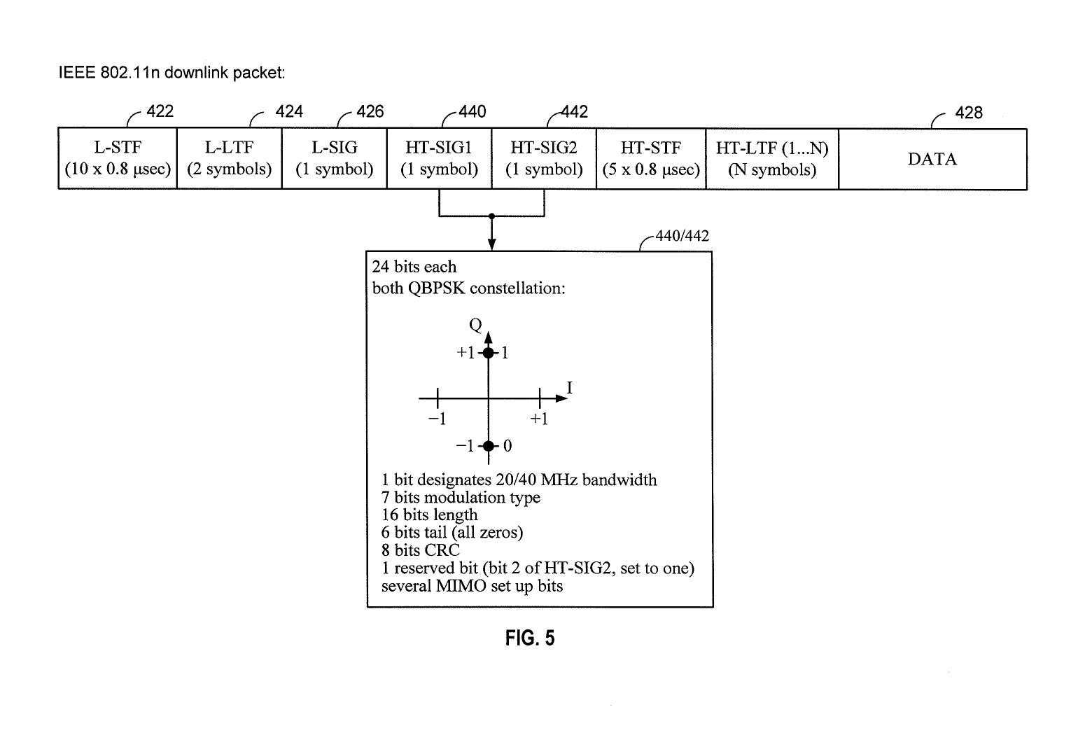

FIG. 6 illustrates a frame format for the currently existing IEEE 802.11ac standard, which added multi-user MIMO functionality to the IEEE 802.11 family. Similar to IEEE 802.11n, an 802.11ac frame includes the same legacy short training field (L-STF) 422 and long training field (L-LTF) 424. An 802.11ac frame also includes a legacy signal field L-SIG 426 as described above.

Next, an 802.11ac frame includes a Very High Throughput Signal (VHT-SIG-A1 450 and A2 452) field two symbols in length. This signal field provides additional configuration information related to 11c features that are not present in 11/b/g and 11n devices. The first OFDM symbol 450 of the VHT-SIG-A can be modulated using BPSK, so that any 802.11n device listening to the packet can believe the packet to be an 802.11a packet, and can defer to the packet for the duration of the packet length as defined in the length field of the L-SIG 426. Devices configured according to 11g can be expecting a service field and MAC header following the L-SIG 426 field. When they attempt to decode this, a CRC failure can occur in a manner similar to the procedure when an 11n packet is received by and 11a/b/g device, and the 11b/g devices can also defer for the period defined in the L-SIG field 426. The second symbol 452 of the VHT-SIG-A is modulated with a 90-degree rotated BPSK. This rotated second symbol allows an 802.11ac device to identify the packet as an 802.11ac packet. The VHT-SIGA1 450 and A2 452 fields include information on a bandwidth mode, modulation and coding scheme (MCS) for the single user case, number of space time streams (NSTS), and other information. The VHT-SIGA1 450 and A2 452 can also include a number of reserved bits that are set to “1.” The legacy fields and the VHT-SIGA1 and A2 fields can be duplicated over each 20 MHz of the available bandwidth. Although duplication may be constructed to mean making or being an exact copy, certain differences may exist when fields, etc. are duplicated as described herein.

After the VHT-SIG-A, an 802.11ac packet can include a VHT-STF, which is configured to improve automatic gain control estimation in a multiple-input and multiple-output (MIMO) transmission. The next 1 to 8 fields of an 802.11ac packet can be VHT-LTFs. These can be used for estimating the MIMO channel and then equalizing the received signal. The number of VHT-LTFs sent can be greater than or equal to the number of spatial streams per user. Finally, the last field in the preamble before the data field is the VHT-SIG-B 454. This field is BPSK modulated, and provides information on the length of the useful data in the packet and, in the case of a multiple user (MU) MIMO packet, provides the MCS. In a single user (SU) case, this MCS information is instead included in the VHT-SIGA2. Following the VHT-SIG-B, the data symbols are transmitted

Although 802.11ac introduced a variety of new features to the 802.11 family, and included a data packet with preamble design that was backward compatible with 11/g/n devices and also provided information necessary for implementing the new features of 11c, configuration information for OFDMA tone allocation for multiple access is not provided by the 11c data packet design. New preamble configurations are desired to implement such features in any future version of IEEE 802.11 or any other wireless network protocol using OFDM subcarriers.

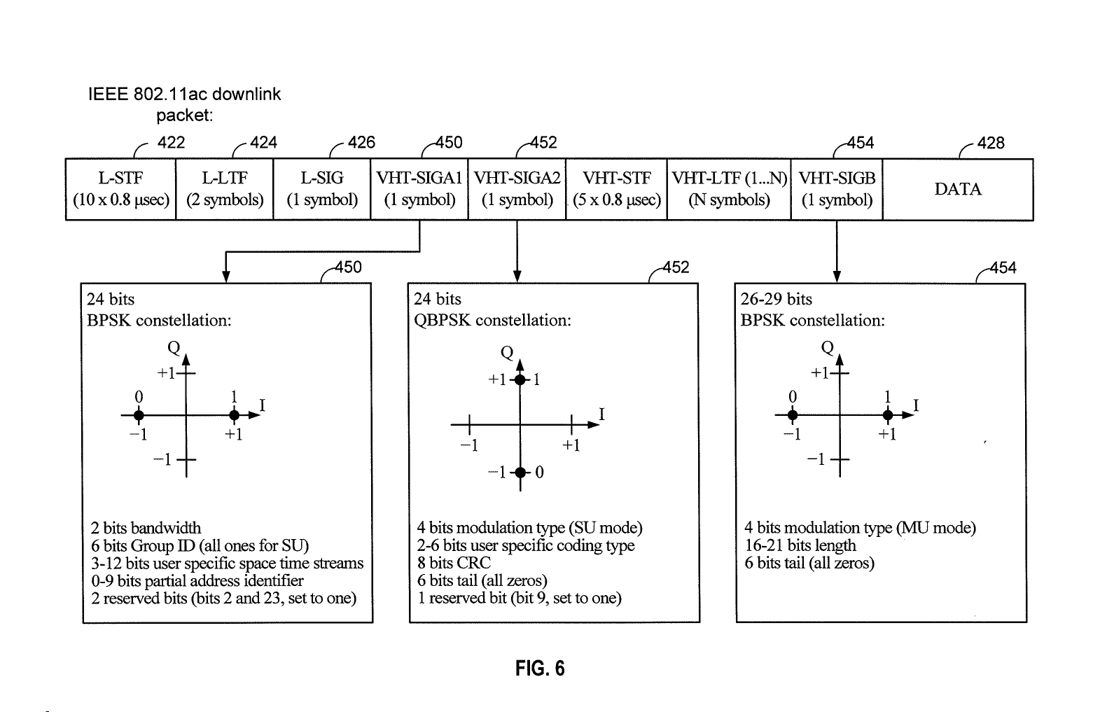

FIG. 7 illustrates an exemplary structure of a physical-layer packet which can be used to enable backward-compatible multiple access wireless communications. In this example physical-layer packet, a legacy preamble including the L-STF 422, L-LTF 426, and L-SIG 426 are included. In various implementations, each of the L-STF 422, L-LTF 426, and L-SIG 426 can be transmitted using 20 MHz, and multiple copies can be transmitted for each 20 MHz of spectrum that the AP 104 (FIG. 1) uses. A person having ordinary skill in the art can appreciate that the illustrated physical-layer packet can include additional fields, fields can be rearranged, removed, and/or resized, and the contents of the fields varied.

This packet also includes an HE-SIG0 symbol 455, and one or more HE-SIG1A symbols 457 (which can be variable in length), and an optional HE-SIG1B symbol 459 (which can be analogous to the VHT-SIG1B field 454 of FIG. 4). In various implementations, the structure of these fields can be backward compatible with IEEE 802.11a/b/g/n/ac devices, and can also signal OFDMA HE devices that the packet is an HE packet. To be backward compatible with IEEE 802.11a/b/g/n/ac devices, appropriate modulation can be used on each of these symbols. In some implementations, the HE-SIG0 field 455 can be modulated with BPSK modulation. This can have the same effect on 802.11a/b/g/n devices as is currently the case with 802.11ac packets that also have their first SIG symbol BPSK modulated. For these devices, it does not matter what the modulation is on the subsequent HE-SIG symbols 457. In various implementations, the HE-SIG0 field 455 can be modulated and repeated across multiple channels.

In various implementations, the HE-SIG1A field 457 can be BPSK or QBPSK modulated. If BPSK modulated, an 11c device can assume the packet is an 802.11a/b/g packet, and can stop processing the packet, and can defer for the time defined by the length field of L-SIG 426. If QBPSK modulated, an 802.11ac device can produce a CRC error during preamble processing, and can also stop processing the packet, and can defer for the time defined by the length field of L-SIG. To signal HE devices that this is an HE packet, at least the first symbol of HE-SIG1A 457 can be QBPSK modulated.

The information necessary to establish an OFDMA multiple access communication can be placed in the HE-SIG fields 455, 457, and 459 in a variety of positions. In various implementations, the HE-SIG0 455 can include one or more of: a duration indication, a bandwidth indication (which can be, for example, 2 bits), a BSS color ID (which can be, for example, 3 bits), an UL/DL indication (which can be, for example, a 1-bit flag), a cyclic redundancy check (CRC) (which can be, for example, 4 bits), and a clear channel assessment (CCA) indication (which can be, for example, 2 bits).

In various implementations, the HE-SIG1 field 457 can include a tone allocation information for OFDMA operation. The example of FIG. 7 can allow four different users to be each assigned a specific sub-band of tones and a specific number of MIMO space time streams. In various implementations, 12 bits of space time stream information allows three bits for each of four users such that 1-8 streams can be assigned to each one. 16 bits of modulation type data allows four bits for each of four users, allowing assignment of any one of 16 different modulation schemes (16QAM, 64QAM, etc.) to each of four users. 12 bits of tone allocation data allows specific sub-bands to be assigned to each of four users.

One example SIG field scheme for sub-band (also referred to herein as sub-channel) allocation includes a 6-bit Group ID field as well as 10 bits of information to allocate sub-band tones to each of four users. The bandwidth used to deliver a packet can be allocated to STAs in multiples of some number of MHz. For example, the bandwidth can be allocated to STAs in multiples of B MHz. The value of B can be a value such as 1, 2, 5, 10, 15, or 20 MHz. The values of B can be provided by a two bit allocation granularity field. For example, the HE-SIG1A 457 can include one two-bit field, which allows for four possible values of B. For example, the values of B can be 5, 10, 15, or 20 MHz, corresponding to values of 0-3 in the allocation granularity field. In some aspects, a field of k bits can be used to signal the value of B, defining a number from 0 to N, where 0 represents the least flexible option (largest granularity), and a high value of N represents the most flexible option (smallest granularity). Each B MHz portion can be referred to as a sub-band.

The HE-SIG1A 457 can further use 2 bits per user to indicate the number of sub-bands allocated to each STA. This can allow 0-3 sub-bands to be allocated to each user. The group-id (G_ID) can be used in order to identify the STAs, which can receive data in an OFDMA packet. This 6-bit G_ID can identify up to four STAs, in a particular order, in this example.

The training fields and data which are sent after the HE-SIG symbols can be delivered by the AP according to the allocated tones to each STA. This information can potentially be beamformed. Beamforming this information can have certain advantages, such as allowing for more accurate decoding and/or providing more range than non-beamformed transmissions.

Depending on the space time streams assigned to each user, different users can use a different number of HE-LTFs 465. Each STA can use a number of HE-LTFs 465 that allows channel estimation for each spatial stream associated with that STA, which can be generally equal to or more than the number of spatial streams. LTFs can also be used for frequency offset estimation and time synchronization. Because different STAs can receive a different number of HE-LTFs, symbols can be transmitted from the AP 104 (FIG. 1) that include HE-LTF information on some tones and data on other tones.

In some aspects, sending both HE-LTF information and data on the same OFDM symbol can be problematic. For example, this can increase the peak-to-average power ratio (PAPR) to too high a level. Thus, it can be beneficial to instead transmit HE-LTFs 465 on all tones of the transmitted symbols until each STA has received at least the required number of HE-LTFs 465. For example, each STA can need to receive one HE-LTF 465 per spatial stream associated with the STA. Thus, the AP can be configured to transmit a number of HE-LTFs 465 to each STA equal to the largest number of spatial streams assigned to any STA. For example, if three STAs are assigned a single spatial stream, but the fourth STA is assigned three spatial streams, in this aspect, the AP can be configured to transmit four symbols of HE-LTF information to each of the four STAs before transmitting symbols including payload data.

It is not necessary that the tones assigned to any given STA be adjacent. For example, in some implementations, the sub-bands of the different receiving STAs can be interleaved. For example, if each of user-1 and user-2 receive three sub-bands, while user-4 receives two sub-bands, these sub-bands can be interleaved across the entire AP bandwidth. For example, these sub-bands can be interleaved in an order such as 1, 2, 4, 1, 2, 4, 1, 2. In some aspects, other methods of interleaving the sub-bands can also be used. In some aspects, interleaving the sub-bands can reduce the negative effects of interferences or the effect of poor reception from a particular device on a particular sub-band. In some aspects, the AP can transmit to STAs on the sub-bands that the STA prefers. For example, certain STAs can have better reception in some sub-bands than in others. The AP can thus transmit to the STAs based at least in part on which sub-bands the STA can have better reception. In some aspects, the sub-bands can also not be interleaved. For example, the sub-bands can instead be transmitted as 1, 1, 1, 2, 2, 2, 4, 4. In some aspects, it can be pre-defined whether or not the sub-bands are interleaved.

In the example of FIG. 7, HE-SIG0 455 symbol modulation can be used to signal HE devices that the packet is an HE packet. Other methods of signaling HE devices that the packet is an HE packet can also be used. In the example of FIG. 7, the L-SIG 426 can include information that instructs HE devices that an HE preamble can follow the legacy preamble. For example, the L-SIG 426 can include a low-energy, 1-bit code on the Q-rail which indicates the presence of a subsequent HE preamble to HE devices sensitive to the Q signal during the L-SIG 426. A very low amplitude Q signal can be used because the single bit signal can be spread across all the tones used by the AP to transmit the packet. This code can be used by high efficiency devices to detect the presence of an HE-preamble/packet. The L-SIG 426 detection sensitivity of legacy devices need not be significantly impacted by this low-energy code on the Q-rail. Thus, these devices can be able to read the L-SIG 426, and not notice the presence of the code, while HE devices can be able to detect the presence of the code. In this implementation, all of the HE-SIG fields can be BPSK modulated if desired, and any of the techniques described herein related to legacy compatibility can be used in conjunction with this L-SIG signaling.

In various implementations, any HE-SIG field 455-459 can include bits defining user-specific modulation type for each multiplexed user. For example, the optional HE-SIG1B 459 field can include bits defining user-specific modulation type for each multiplexed user.

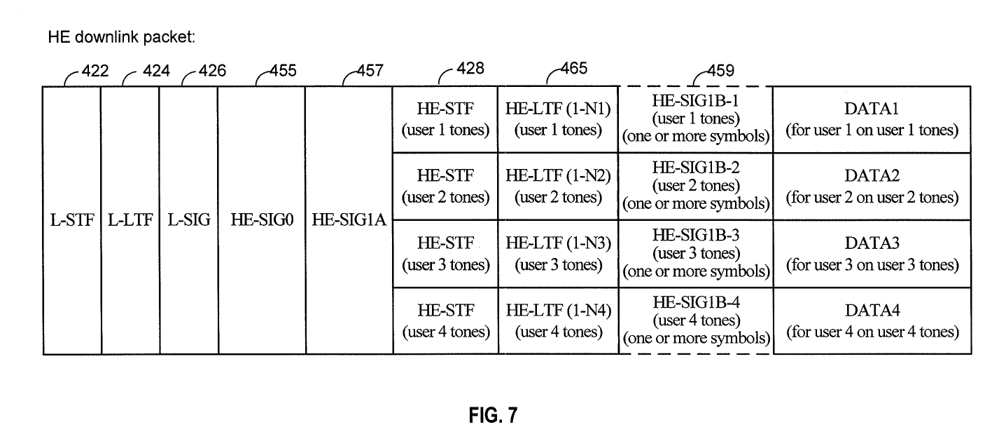

FIG. 8 is a block diagram of an access point 104 and stations 106 in an OFDMA system, according to some implementations. As shown in FIG. 8 and in conjunction with FIG. 1, the AP 104 and the STAs 106A-106D are part of an 80 MHz BSS. In the illustrated implementation, the STAs 106A-106D are located at the edge of the BSS and have one 20 MHz channel available. The AP 104 can send the STAs 106A-106D an OFDMA transmission over the 20 MHz channels (i.e., OFDMA transmissions 301A-301D). The remaining 60 MHz bandwidth can be unavailable because of overlapping basic service set (OBSS) interference.

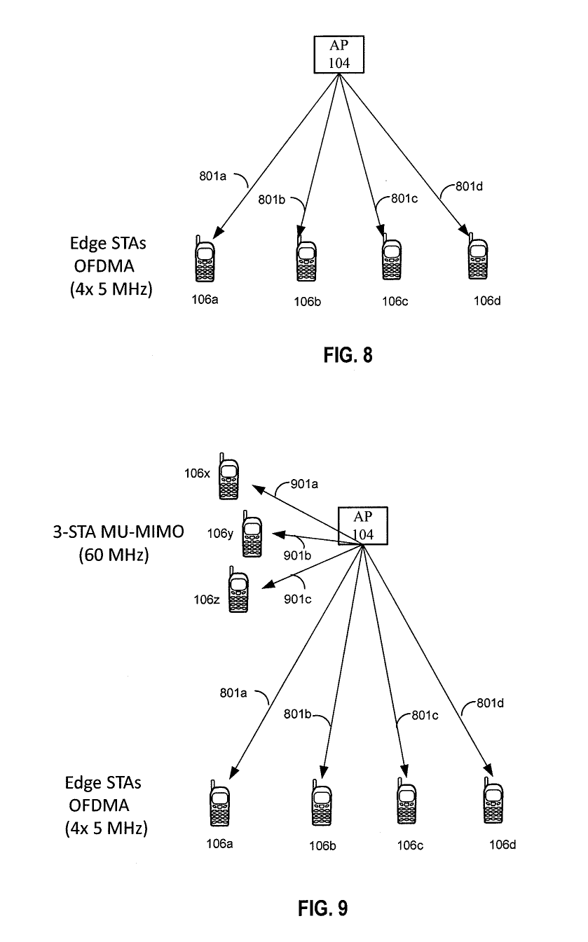

Certain aspects of the present disclosure support mixing MU-MIMO and OFDMA techniques in the frequency domain in a same PPDU. In some implementations, a first portion of the PPDU bandwidth can be transmitted as one of at least a MU-MIMO transmission and an OFDMA transmission. A second portion of the PPDU bandwidth can be transmitted as one of at least a MU-MIMO transmission and an OFDMA transmission. In various implementations, each portion, where at least one wireless device is assigned to multiple channels of a common transmission type, can be referred to as a “zone.” Thus, in various implementations, the first and second portions can include any combination such as MU-MIMO/OFDMA, MU-MIMO/MU-MIMO, and OFDMA/OFDMA. In some implementations, the PPDU bandwidth can include more than two portions or zones. In some implementations, the PPDU bandwidth can be limited to a single zone or a maximum of two zones. For example, FIG. 9 illustrates a two-zone configuration including MU-MIMO transmissions 901A-901C and OFDMA transmissions 801A-801D. In these implementations, MU-MIMO or OFDMA transmissions can be sent simultaneously from an AP to multiple STAs and can create efficiencies in wireless communication.

FIG. 9 is a block diagram of the AP 104 and the STAs 106A-106D and 160X-160Z in a mixed MU-MIMO and OFDMA system, according to some implementations. In the illustrated implementation, the STAs 106A-106D have one 20 MHz channel that is available as in FIG. 8 and the AP 104 can send OFDMA transmissions 801A-801D to the STAs 106A-106D over the 20 MHz channel. In this aspect, the AP 104 can also send MU-MIMO transmissions 901A-901C to STAs 106X-106Z that are close to the AP 104 over the remaining 60 MHz portion of the bandwidth. By sending an MU-MIMO packet to the STAs 106X-106Z over the previously un-used 60 MHz portion of the bandwidth, the AP 104 can increase throughput by using a combination of OFDMA and MU-MIMO transmissions.

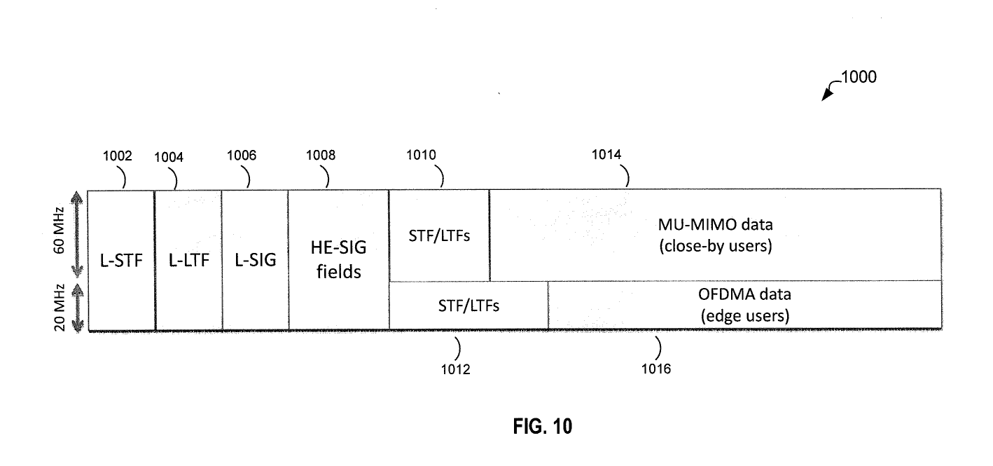

FIG. 10 is a diagram of a mixed physical layer data unit (PPDU) 1000 packet format, including OFDMA and MU-MIMO portions, according to some implementations. Such a mixed PPDU can be transmitted by a wireless device, such as an AP 104. The PPDU 1000 can include a legacy portion, which includes legacy fields: legacy short training field (L-STF) 1002; legacy long training field (L-LTF) 1004; and legacy signal field (L-SIG) 1006. The legacy fields 1002, 1004, and 1006 can be duplicated in every 20 MHz channel.

PPDU 1000 can also include a high-efficiency signal field (HE-SIG) 1008, which includes certain signaling information for the PPDU 1000. In some implementations, the HE-SIG 1008 can include a bit to indicate that the PPDU 1000 includes both MU-MIMO and OFDMA portions. The HE-SIG 1008 can also include stream allocation (for MU-MIMO STAs) and tone allocation (for OFDMA STAs) information.

As shown in FIG. 10, the MU-MIMO portion of the PPDU 1000 packet is in the top 60 MHz of the bandwidth and the MU-MIMO portion includes a STF/LTFs field 1010 and a MU-MIMO data portion 1014. The OFDMA portion of the PPDU 1000 packet is in the bottom 20 MHz of the bandwidth and includes a STF/LTFs field 1012 and a OFDMA data portion 1016. Although 20 MHz channels are illustrated, with the total bandwidth being divided between MU-MIMO and OFDMA illustrated as a 60 MHz/20 MHz split, different channel widths and splits are contemplated. For example, in some implementations, zones can be any integer multiple number of a channel width such as 20 MHz, 40 MHz, 60 MHz, etc.

While FIG. 10 illustrates the STF/LTFs field 1012 is larger than the STF/LTFs field 1010, either field STF/LTFs 1010 or 1012 can be any size such that in some implementations, STF/LTFs field 1010 can be larger or equal to STF/LTFs field 1012. When transmitting a PPDU 1000 packet an AP 104 can allocate part of its bandwidth to transmit the MU-MIMO portion (fields 1010 and 1014) and the remaining bandwidth can be used to transmit the OFDMA portion (fields 1012 and 1016).

As discussed in connection with FIG. 10, a HE-SIG field 1008 can signal the allocation of STAs across the MU-MIMO and OFDMA portions of the PPDU 1000 packet bandwidth. In some implementations, the HE-SIG field 1008 can include a two-bit field to indicate the packet bandwidth. The HE-SIG field 1008 can also include a one-bit field to indicate whether the packet is a mixture of MU-MIMO and OFDMA or not. The HE-SIG field 1008 can also include a one-bit field to indicate whether the MU-MIMO portion is in the top portion of the bandwidth or not. The HE-SIG field 1008 can also include a four-bit field to indicate the bandwidth of the MU-MIMO portion of the packet. In some implementations, the MU-MIMO portion can be anywhere from 20-160 MHz and the remaining bandwidth can be allocated for the OFDMA portion. In some implementations, the bandwidth of the MU-MIMO and OFDMA portions of the PPDU can be multiples of 20 MHz. The HE-SIG field 1008 can also include a six-bit group identifier (GID) field to indicate the group of STAs for the MU-MIMO portion and a six-bit GID field to indicate the group of STAs for the OFDMA portion.

As discussed above, for example with respect to FIG. 1, in various implementations, the wireless system 100 can be configured to serve a large number of stations. As the number of stations in a wireless system 100 increases, the number of signaling bits used for tone or stream allocation can also increase. In various implementations, a static number of bits can be used for tone allocation. In some implementations, the AP 104 may only send data to a small number of stations. Accordingly, tone allocation bits in a static allocation can go unused, increasing signaling overhead. Thus, efficient systems and methods for allocating tones in multi-zone systems are desired. In various implementations, a SIG field (such as the HE-SIG1A 457 field of FIG. 7) can have a variable length in order to decrease signaling overhead. For example, in various implementations the HE-SIG fields 1008 of FIG. 10 can include HE-SIG0, HE-SIG1A, and/or HE-SIG1B fields, as discussed above with respect to FIG. 7.

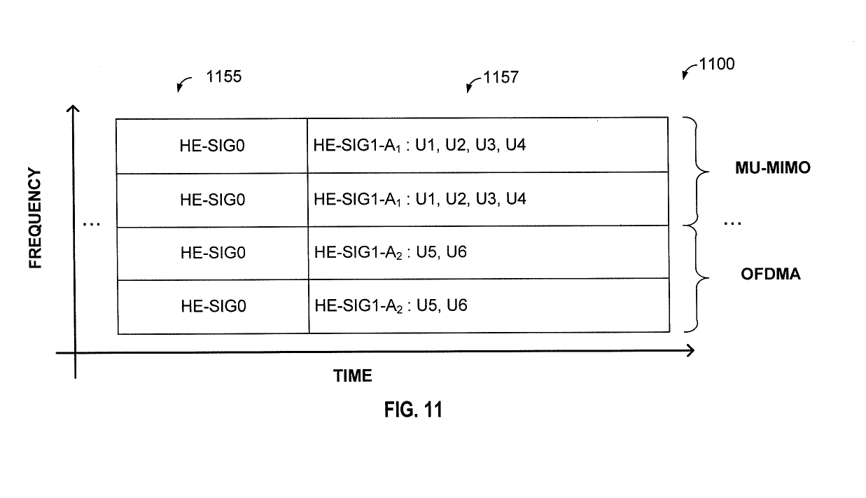

FIG. 11 illustrates portions of exemplary structures of a physical-layer packet 1100, according to some implementations. As shown in FIG. 11, the packet 1100 includes a plurality of HE-SIG0 fields 1155, each of which can be separately modulated across frequency sub-channels. The packet 1100 further includes a single HE-SIG1A field 1157 that can be modulated across an entire channel (or a plurality of sub-channels). In various implementations, the packet 1100 can be similar to one or more of the packets discussed above with respect to FIGS. 4-7. For example, the HE-SIG0 fields 1155 can include one or more fields discussed above with respect to the HE-SIG0 field 455 of FIG. 7, and the HE-SIG1 field 1157 can include one or more fields discussed above with respect to the HE-SIG1 field 457 of FIG. 7. Likewise, portion of the packet 1100 shown in FIG. 11 can correspond to, for example, the HE-SIG fields 1108 shown in FIG. 1. Although the packet 1100 is described below with respect to the AP 104 and the STAs 106A-106D of the wireless system 100 of FIG. 1, the packet 1100 can be generated, decoded, transmitted, and/or received by any other device according to various implementations. A person having ordinary skill in the art can appreciate that the illustrated physical-layer packet can include additional fields, fields can be rearranged, removed, and/or resized, and the contents of the fields varied.

In some implementations, the AP 104 can separately encode and transmit the HE-SIG1A fields 1157 across all sub-channels. Accordingly, the content of the HE-SIG1A fields 1157 can be different on one or more sub-channels. In various implementations, the AP 104 can determine one or more STAs 106 on each sub-channel, and can encode information specific to each STA 106 on the corresponding sub-channel. For example, the AP 104 can encode station-specific allocations such as group identifiers (GIDs), association identifiers (AIDs), partial AIDs (PAIDs), etc. In some implementations, the STA 106B can receive and decode the HE-SIG1A 1157B fields on a single (or plurality of) sub-channels. In some implementations, STAs 106 can decode information on every sub-channel.

As discussed above, in various implementations the AP 104 can encode an AID or PAID on each HE-SIG1 1157 in order to identify message recipients for that sub-channel. In various implementations, for example, each HE-SIG1 1157 can include a station indication such as a 12-bit AID, an 11-bit PAID, an encoded AID (using, e.g., Huffman encoding), etc. In various implementations, the station indication can indicate one or more STAs 106 that are recipients for an OFDMA zone. In various implementations, there can be 4 or 8 recipients for an OFDMA zone. Accordingly, each STA 106 can determine a sub-channel allocation without the complexity of GID management.

In some implementations, each STA 106 can decode the HE-SIG1A 1157 on all sub-channels. Each STA 106 can determine if its station indicator is indicated on each sub-channel. For sub-channels that carry a HE-SIG1A 1157 indicating the STA 106, the STA 106 can determine that those sub-channels are allocated to the STA 106. In various implementations, the AP 104 can determine whether each sub-channel is clean to each destination STA 106, and can assign clean sub-channels using the station indications in the HE-SIG1A 1157. In some implementations, the AP 104 can encode a bit in each HE-SIG1A 1157 to indicate whether the sub-channel on which it is transmitted is intended for MU-MIMO or OFDMA. Similarly, the STA 106 can decode the bit in each HE-SIG1A 1157 to determine whether the sub-channel on which it is transmitted is intended for MU-MIMO or OFDMA.

In some implementations, the AP 104 can determine one or more sub-channels for transmission to the STAs 106. For example, the AP 104 can determine that a sub-channel of a MU-MIMO zone HE-SIG1-A₁ is clear for stations U1, U2, U3, and U4 and that a sub-channel of an OFDMA zone HE-SIG1-A₂ is clear for stations U5 and U6. Accordingly, the AP 104 can encode station identifiers (such as AIDs) for U1, U2, U3, and U4 on the HE-SIG1-A₁, and so on. The AP 104 can repeat the allocation information across each sub-channel for each zone, for example by encoding a common HE-SIG1B field 1157 for adjacent zone sub-channels. Thus, any particular STA can receive allocations on at least one sub-channel in a zone, even though it might not be capable of receiving allocations on every sub-channel.

By way of example, the AP 104 can determine that a STA U4 is in a first MU-MIMO zone. Thus, the AP 104 can encode the AID of U4 in the HE-SIG1-A₁ 1157, which can be duplicated across both sub-channels of the MU-MIMO zone. The STA U4 can decode every sub-channel in the HE-SIG1-A 1157. For those sub-channels in which the STA U4 is able to decode the HE-SIG1-A 1157, and in which the AID of the STA U4 is present, the STA U4 can determine that that zone carries data for it. In various implementations, this approach can reduce management signaling and increase channel flexibility on a packet-by-packet basis

In some implementations, the AP 104 can encode the HE-SIG1-A fields 1157 over the entire bandwidth for OFDMA zones, instead of separately encoding duplicated fields over each sub-channel as illustrated. For example, the AP 104 can encode the HE-SIG1-A₂ 1157 across the entire bandwidth of the OFDMA zone. In some implementations, this approach can cause an ODFMA SIG1-A field to terminate prior to a MU-MIMO HE-SIG1-A field. In other implementations with two OFDMA zones, the SIG1-A field for both zones can terminate at the same time.

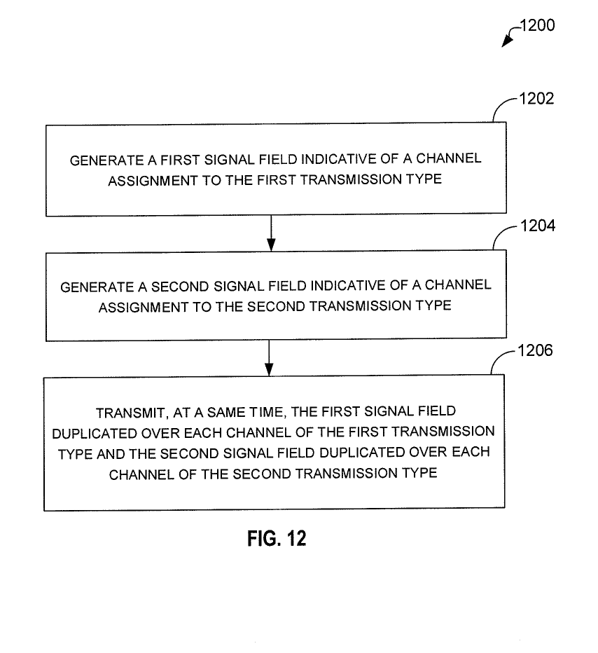

FIG. 12 shows another flowchart 1200 for an exemplary method of wireless communication that can be employed within the wireless communication system 120 of FIG. 1. The method can be implemented in whole or in part by the devices described herein, such as the wireless device 202 shown in FIG. 2. Although the illustrated method is described herein with reference to the wireless communication system 100 discussed above with respect to FIG. 1 and the packets 1000 and 1100 discussed above with respect to FIGS. 10-11, a person having ordinary skill in the art will appreciate that the illustrated method can be implemented by another device described herein, or any other suitable device. Although the illustrated method is described herein with reference to a particular order, in various implementations, blocks herein can be performed in a different order, or omitted, and additional blocks can be added.

First, at block 1202, an access point generates a first signal field indicative of a channel assignment to a first transmission type. The first signal field can be a field of a packet comprising a first portion for transmission over at least one channel of the first transmission type and a second portion for transmission over at least one channel of a second transmission type. For example, the packet can include the packet 1100 of FIG. 11, the first portion can include the MU-MIMO portion of FIG. 11, and the second portion can include the OFDMA portion of FIG. 11. The first signal field can include the HE-SIG1-A₁ 1157. In the example of FIG. 11, the first signal field indicates a list of devices U1-U4 assigned to the MU-MIMO zone.

Next, at block 1204, the access point generates a second signal field indicative of a channel assignment to the second transmission type. For example, the second signal field can include the HE-SIG1-A₂ 1157. In the example of FIG. 11, the second signal field indicates a list of devices U5-U6 assigned to the OFDMA zone.

Then, at block 1206, the access point transmits, at a same time, the first signal field duplicated over each channel of the first transmission type and the second signal field duplicated over each channel of the second transmission type. For example, the AP 104 can duplicate the HE-SIG1-A₁ 1157 over each sub-channel of the MU-MIMO zone (separately modulate the same data over each sub-channel). The AP 104 can duplicate the HE-SIG1-A₂ 1157 over each sub-channel of the OFDMA zone (separately modulate the same data over each sub-channel). One or more STAs 106 can receive the first and second messages. With respect to block 1206, the term “at a same time” may be considered to mean at exactly the same time, at substantially or essentially the same time allowing for small margins of error, or during overlapping time periods.

In various implementations, the first transmission type can include orthogonal frequency division multiple access (OFDMA) and the second transmission type can include multiple-user multiple-input multiple-output (MU-MIMO), or vice versa. For example, the packet 1100 of FIG. 11 can include an OFDMA zone followed by a MU-MIMO zone, or a MU-MIMO zone followed by an OFDMA zone.

In various implementations, both the first and second transmission types can include orthogonal frequency division multiple access (OFDMA). For example, the packet 1100 of FIG. 11 can include an OFDMA zone followed by an OFDMA zone.

In various implementations, both the first and second transmission types can include multiple-user multiple-input multiple-output (MU-MIMO). For example, the packet 1100 of FIG. 11 can include a MU-MIMO zone followed by a MU-MIMO zone.

In various implementations, the access point can further generate a third signal field indicative of a length of the first signal field, and can transmit the third signal field, duplicated over each channel of the first transmission type and over each channel of the second transmission type, preceding the first signal field and the second signal field. For example, the AP 104 can generate the HE-SIG0 1155 (FIG. 11) as the third signal field, which can indicate a length of the HE-SIG1-A 1157 fields. The AP 104 can duplicate the HE-SIG0 1155 over each sub-channel of the packet 1100 (separately modulate the same data over each sub-channel).

In various implementations, the packet can include no more than two zones. For example, the packet 1100 can be limited to just one or two zones. Thus, in some implementations, the entire packet 1100 can include just a single OFDMA zone or a single MU-MIMO zone.

In various implementations, the packet can include no more than a single zone, wherein the first transmission type and the second transmission type comprise the same transmission type. For example, in implementations where the packet 1100 is limited to a single zone, the first portion and the second portion can combine to form a single OFDMA or MU-MIMO zone.

In various implementations, at least one channel assignment can include one or more of: one or more association identifications, one or more partial association identifications, and one or more group identifications. In various implementations, the access point can determine the channel assignments based on a clear channel assessment. In various implementations, the access point can assign at least one wireless device to multiple channels, of the same transmission type, forming a zone.

In various implementations, at least one of the first signal field and the second signal field includes an indication of orthogonal frequency division multiple access (OFDMA) allocation unit size. For example, the AP 104 can include an indication of allocation bandwidth for each zone, such as the OFDMA zone shown in FIG. 11. Thus, the AP 104 could indicate, for example, that allocations are provided in 5 MHz units, 20 MHz units, etc. In various implementations, the allocation size indication can be included in another field, or in a separate communication entirely.

In various implementations, an orthogonal frequency division multiple access (OFDMA) allocation unit size is implicitly based on a bandwidth of an OFDMA zone. For example, the AP 104 can indicate allocations within each zone without including an indication of allocation unit size. Thus, the AP 104 and/or the STA 106 can implicitly determine the allocation unit size based on a bandwidth of each zone. For example, in a 20 MHz zone, the AP 104 and/or the STA 106 can determine that bandwidth is allocated in 5 MHz allocation units, whereas in an 80 MHz zone, the AP 104 and/or the STA 106 can determine that bandwidth is allocated in 20 MHz allocation units. In some implementations, the AP 104 can determine a zone for each STA based, at least in part, on an intended allocation bandwidth for that STA.

In some implementations, the method shown in FIG. 12 can be implemented in a wireless device that can include a generating circuit and a transmitting circuit. Those skilled in the art will appreciate that a wireless device can have more components than the simplified wireless device described herein. The wireless device described herein includes only those components useful for describing some prominent features of implementations within the scope of the claims.

The generating circuit can be configured to generate the first and second messages. In some implementations, the generating circuit can be configured to perform at least block 1202 and/or 1204 of FIG. 12. The generating circuit can include one or more of the processor 204 (FIG. 2), the memory 206 (FIG. 2), and the DSP 220 (FIG. 2). In some implementations, means for generating can include the generating circuit.

The transmitting circuit can be configured to transmit the first and second messages together. In some implementations, the transmitting circuit can be configured to perform at least block 1206 of FIG. 12. The transmitting circuit can include one or more of the transmitter 210 (FIG. 2), the antenna 216 (FIG. 2), and the transceiver 214 (FIG. 2). In some implementations, means for transmitting can include the transmitting circuit.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can include non-transitory computer readable medium (e.g., tangible media). In addition, in some aspects computer readable medium can include transitory computer readable medium (e.g., a signal). Combinations of the above can also be included within the scope of computer-readable media.

The methods disclosed herein include one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Further, it can be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

1. A method of wirelessly communicating a packet comprising a first portion for transmission over a channel of a first transmission type and a second portion for transmission over a channel of a second transmission type, comprising:
generating a first signal field indicative of a channel assignment to the first transmission type,
generating a second signal field indicative of a channel assignment to the second transmission type, and
transmitting, at a same time, the first signal field duplicated over each channel of the first transmission type and the second signal field duplicated over each channel of the second transmission type.

2. The method of claim 1, wherein the channel assignment to the first transmission type comprises assignment to orthogonal frequency division multiple access (OFDMA) and the channel assignment to the second transmission type comprises assignment to multiple-user multiple-input multiple-output (MU-MIMO).

3. The method of claim 1, wherein the channel assignment to the first transmission type comprises assignment to orthogonal frequency division multiple access (OFDMA) and the channel assignment to the second transmission type comprises assignment to OFDMA.

4. The method of claim 1, wherein the channel assignment to the first transmission type comprises assignment to multiple-user multiple-input multiple-output (MU-MIMO) and the channel assignment to the second transmission type comprises assignment to MU-MIMO.

5. The method of claim 1, further comprising:
generating a third signal field indicative of a length of the first signal field, and
transmitting the third signal field, duplicated over each channel of the first transmission type and over each channel of the second transmission type, preceding the first signal field and the second signal field.

6. The method of claim 1, wherein at least one of the channel assignment to the first transmission type and the channel assignment to the second transmission type comprises one or more of: one or more association identifications, one or more partial association identifications, and one or more group identifications.

7. The method of claim 1, further comprising determining the channel assignment to the first transmission type and the channel assignment to the second transmission type based on at least a clear channel assessment.

8. The method of claim 1, further comprising forming at least one zone by assigning at least one wireless device to multiple channels of a common transmission type.

9. The method of claim 8, wherein the communication of the packet comprises forming no more than two zones.

10. The method of claim 8, wherein the communication of the packet comprises forming no more than a single zone and wherein the first transmission type and the second transmission type comprise a common transmission type.

11. The method of claim 1, wherein at least one of the first signal field and the second signal field comprises an indication of orthogonal frequency division multiple access (OFDMA) allocation unit size.

12. The method of claim 1, wherein an orthogonal frequency division multiple access (OFDMA) allocation unit size is implicitly based on a bandwidth of an OFDMA zone.

13. An apparatus configured to wirelessly communicate a packet comprising a first portion for transmission over a channel of a first transmission type and a second portion for transmission over a channel of a second transmission type, comprising:
a processor configured to:
generate a first signal field indicative of a channel assignment to the first transmission type, and
generate a second signal field indicative of a channel assignment to the second transmission type, and
a transmitter configured to transmit, at a same time, the first signal field duplicated over each channel of the first transmission type, and the second signal field duplicated over each channel of the second transmission type.

14. The apparatus of claim 13, wherein the channel assignment to the first transmission type comprises assignment to orthogonal frequency division multiple access (OFDMA) and the channel assignment to the second transmission type comprises assignment to multiple-user multiple-input multiple-output (MU-MIMO).

15. The apparatus of claim 13, wherein the channel assignment to the first transmission type comprises assignment to orthogonal frequency division multiple access (OFDMA) and the channel assignment to the second transmission type comprises assignment to OFDMA.

16. The apparatus of claim 13, wherein the channel assignment to the first transmission type comprises assignment to multiple-user multiple-input multiple-output (MU-MIMO) and the second channel assignment to the transmission type comprises assignment to MU-MIMO.

17. The apparatus of claim 13, wherein:
the processor is further configured to generate a third signal field indicative of a length of the first signal field; and
the transmitter is further configured to transmit the third signal field, duplicated over each channel of the first transmission type and over each channel of the second transmission type, preceding the first signal field and the second signal field.

18. The apparatus of claim 13, wherein at least one of the channel assignment to the first transmission type and the channel assignment to the second transmission type comprises one or more of: one or more association identifications, one or more partial association identifications, and one or more group identifications.

19. The apparatus of claim 13, wherein the processor is further configured to determine the channel assignment to the first transmission type and the channel assignment to the second transmission type based on at least a clear channel assessment.

20. The apparatus of claim 13, wherein the processor is further configured to form at least one zone by assigning at least one wireless apparatus to multiple channels of a common transmission type.

21. The apparatus of claim 20, wherein the communication of the packet comprises forming no more than two zones.

22. The apparatus of claim 20, wherein the communication of the packet comprises forming no more than a single zone and wherein the first transmission type and the second transmission type comprise a common transmission type.

23. The apparatus of claim 13, wherein at least one of the first signal field and the second signal field comprises an indication of orthogonal frequency division multiple access (OFDMA) allocation unit size.

24. The apparatus of claim 13, wherein an orthogonal frequency division multiple access (OFDMA) allocation unit size is implicitly based on a bandwidth of an OFDMA zone.

25. An apparatus for wirelessly communicating a packet comprising a first portion for transmission over a channel of a first transmission type and a second portion for transmission over a channel of a second transmission type, comprising:
means for generating a first signal field indicative of a channel assignment to the first transmission type;
means for generating a second signal field indicative of a channel assignment to the second transmission type; and
means for transmitting, at a same time, the first signal field duplicated over each channel of the first transmission type, and the second signal field duplicated over each channel of the second transmission type.

26. The apparatus of claim 25, wherein the channel assignment to the first transmission type comprises assignment to orthogonal frequency division multiple access (OFDMA) and the channel assignment to the second transmission type comprises assignment to multiple-user multiple-input multiple-output (MU-MIMO).

27. The apparatus of claim 25, wherein the channel assignment to the first transmission type comprises assignment to orthogonal frequency division multiple access (OFDMA) and the channel assignment to the second transmission type comprises assignment to OFDMA.

28. The apparatus of claim 25, wherein the channel assignment to the first transmission type comprises assignment to multiple-user multiple-input multiple-output (MU-MIMO) and the channel assignment to the second transmission type comprises assignment to MU-MIMO.

29. The apparatus of claim 25, further comprising:
means for generating a third signal field indicative of a length of the first signal field; and
means for transmitting the third signal field, duplicated over each channel of the first transmission type and over each channel of the second transmission type, preceding the first signal field and the second signal field.

30. The apparatus of claim 25, wherein at least one of the channel assignment to the first transmission type and the channel assignment to the second transmission type comprises one or more of: one or more association identifications, one or more partial association identifications, and one or more group identifications.

31. The apparatus of claim 25, further comprising means for determining the channel assignment to the first transmission type and the channel assignment to the second transmission type based on at least a clear channel assessment.

32. The apparatus of claim 25, further comprising means for forming at least one zone by assigning at least one wireless device to multiple channels of a common transmission type.

33. The apparatus of claim 32, wherein communication of the packet comprises forming no more than two zones.

34. The apparatus of claim 32, wherein the communication of the packet comprises forming no more than a single zone and wherein the first transmission type and the second transmission type comprise a common transmission type.

35. The apparatus of claim 25, wherein at least one of the first signal field and the second signal field comprises an indication of orthogonal frequency division multiple access (OFDMA) allocation unit size.

36. The apparatus of claim 25, wherein an orthogonal frequency division multiple access (OFDMA) allocation unit size is implicitly based on a bandwidth of an OFDMA zone.

37. A non-transitory computer-readable medium comprising code that, when executed, causes an apparatus to:
generate a first signal field of a packet comprising a first portion for transmission over a channel of a first transmission type and a second portion for transmission over a channel of a second transmission type, the first signal field indicative of a channel assignment to the first transmission type;
generate a second signal field indicative of a channel assignment to the second transmission type; and
transmit, at a same time, the first signal field duplicated over each channel of the first transmission type, and the second signal field duplicated over each channel of the second transmission type.

38. The medium of claim 37, wherein the channel assignment to the first transmission type comprises assignment to orthogonal frequency division multiple access (OFDMA) and the channel assignment to the second transmission type comprises assignment to multiple-user multiple-input multiple-output (MU-MIMO).

39. The medium of claim 37, wherein the channel assignment to the first transmission type comprises assignment to orthogonal frequency division multiple access (OFDMA) and the channel assignment to the second transmission type comprises assignment to OFDMA.

40. The medium of claim 37, wherein the channel assignment to the first transmission type comprises assignment to multiple-user multiple-input multiple-output (MU-MIMO) and the channel assignment to the second transmission type comprises assignment to MU-MIMO.

41. The medium of claim 37, further comprising code that, when executed, causes the apparatus to:
generate a third signal field indicative of a length of the first signal field; and
transmit the third signal field, duplicated over each channel of the first transmission type and over each channel of the second transmission type, preceding the first signal field and the second signal field.

42. The medium of claim 37, wherein at least one of the channel assignment to the first transmission type and the channel assignment to the second transmission type comprises one or more of: one or more association identifications, one or more partial association identifications, and one or more group identifications.

43. The medium of claim 37, further comprising code that, when executed, causes the apparatus to determine the channel assignment to the first transmission type and the channel assignment to the second transmission type based on at least a clear channel assessment.

44. The medium of claim 37, further comprising code that, when executed, causes the apparatus to form at least one zone by assigning at least one wireless device to multiple channels of a common transmission type.

45. The medium of claim 37, wherein the communication of the packet comprises forming no more than two zones.

46. The medium of claim 37, wherein the communication of the packet comprises forming no more than a single zone and wherein the first transmission type and the second transmission type comprise a same transmission type.

47. The medium of claim 37, wherein at least one of the first signal field and the second signal field comprises an indication of orthogonal frequency division multiple access (OFDMA) allocation unit size.

48. The medium of claim 37, wherein an orthogonal frequency division multiple access (OFDMA) allocation unit size is implicitly based on a bandwidth of an OFDMA zone.
